(19) United States
(12) Patent Application Publication
(10) Pub. No.: US 2026/0142747 A1
(43) Pub. Date: May 21, 2026

(54) METHODS AND SYSTEMS FOR TRANSMITTING DATA PACKETS BETWEEN NETWORK DEVICES

(71) Applicant: Pismo Labs Technology Limited, Kowloon (HK)

(72) Inventors: Wan Chun LEUNG, Kowloon (HK); Alex Wing Hong CHAN, Kowloon (HK)

(73) Assignee: Pismo Labs Technology Limited, Kowloon (HK)

(21) Appl. No.: 18/952,676

(22) Filed: Nov. 19, 2024

(51) Int. Cl. H04L 1/00; H04L 43/0829

(52) U.S. Cl. CPC H04L 1/004; H04L 43/0829

(57) ABSTRACT

The method for transmitting data packets from a first network device to a second network device is disclosed. When the error correction mode is enabled, the first network device may transmit a first plurality of data packets to the second network device through the end-to-end connections, and then receive a second plurality of data packets from the second network device through the end-to-end connections. The first network device may determine a first value for each of the at least one of the end-to-end connections according to the first information obtained, and transmit a third plurality of data packets to the second network device through the end-to-end connections.

### TECHNICAL FIELD

The present invention relates generally to the field of computer networks. More particularly, the present invention discloses methods and systems for handling packet loss when transmitting data packets through a plurality of connections from a first network device to a second network device.

### BACKGROUND ART

Wireless communications are susceptible to unpredictable data packet transmission quality, often experiencing packet loss with fluctuating packet loss rate and packet drop rate. To ensure reliable data transmission in real-time wireless communications and the quality of the overall data packet transmission, various techniques are employed to mitigate packet loss in real-time communications, including re-transmission of the lost packet and application of forward error correction (FEC). FEC techniques involve adding redundancy to the transmitted data, allowing the receiving network device to detect and correct errors/losses without retransmission.

Conventional FEC techniques involve transmitting error correction packets across a plurality of connections to recover lost data at the receiving device. This approach enhances data transmission reliability, particularly in noisy and unreliable channels such as satellite communications. Common FEC codes, such as Hamming code, Reed-Solomon code, and Turbo code, each have different levels of complexity and error-correcting capability.

However, applying conventional FEC techniques across all connections in the plurality of connections even when some experience no packet loss may waste resources. For example, the overall data packet transmission rate may decrease because of the FEC overhead, in which redundant data for error correction is added to every packet being transmitted across the plurality of connections, regardless of whether a particular connection requires it. This results in inefficient utilization of available bandwidth, especially in scenarios with low or fluctuating packet loss rates across different connections in the plurality of connections. Additionally, the computational complexity associated with FEC encoding and decoding may increase power consumption and latency, further degrading overall system performance.

This present invention introduces a new FEC technique with various embodiments that balance between error correction capability and system efficiency. Unlike conventional FEC techniques that apply a fixed error correction overhead to all data packets, the proposed FEC adjusts the level of redundancy dynamically based on real-time channel conditions. This new approach is expected to significantly enhance data transmission reliability while minimizing overhead and computational costs, particularly in environments with fluctuating channel quality.

### SUMMARY

The present invention discloses methods and systems for transmitting data packets between a first network device and a second network device. A first network device may enable the error correction mode on each of the plurality of connections to compensate the lost packet.

The first network device may determine whether an error correction mode is enabled or not. When the error correction mode is enabled, the first network device may transmit a second plurality of data packets to the second network device to request the first information, which is about packet loss in the plurality of connections. In response, the second network device may transmit a third plurality of data packets comprising the first information to the first network device through the plurality of connections. If there is packet loss in the at least one connection of the end-to-end connections, the first network device may transmit a fourth plurality of data packets, which is a combination of the original data packet(s) and the error correction packet(s).

According to the embodiments of the present invention, before transmitting the fourth plurality of data packets, the first network device determines a second value for each of the at least one connection. The second value reflects the seriousness of packet loss in the at least one connection of the end-to-end connections.

According to the embodiments of the present invention, the ratio between the number of error correction packets and the number of original data packets being transmitted is based on a first value.

According to the embodiments of the present invention, the first network device may assign the first value for a particular connection to reflect the number of packets lost in the particular connection. The first network device may update the first value if any of the end-to-end connections satisfies a first criteria, which is a condition related to the second value.

According to the embodiments of the present invention, the first network device may disable the error correction mode if a second criteria is satisfied.

### BRIEF DESCRIPTION OF DRAWINGS

FIG. 1A is an illustrative block diagram of the network environment according to the embodiments of the present invention.

FIG. 1B is a block diagram illustrating a plurality of connections established between two network devices according to the embodiments of the present invention.

FIG. 2A is an illustrative block diagram of a first network device according to the embodiments of the present invention.

FIG. 2B is an illustrative block diagram of a second network device according to the embodiments of the present invention.

FIG. 3 is a diagram illustrating the difference between the packet structure of the original data packet and that of the error correction packet according to the embodiments of the present invention.

FIG. 4 is a diagram illustrating a method for handling packet loss at the first network device according to the embodiments of the present invention.

FIG. 5 is a diagram illustrating a method for handling packet loss at the second network device according to the embodiments of the present invention.

FIG. 6 is a diagram illustrating how the first value of a particular connection is determined from its corresponding packet loss rate, and how the first value is updated according to the embodiments of the present invention.

FIG. 7 is an example of the data packets being transmitted between network devices through a particular connection according to the embodiments of the present invention.

### DETAILS

The present invention effectively addresses the shortfall of conventional FEC techniques. It discloses systems and methods for transmitting data packets between network devices that enhance network performance by adaptively adjusting the resources used in compensating for the loss of packets to maintain the quality of overall data packet transmission.

The ensuing description discusses preferred exemplary embodiment(s) and exemplary embodiments only, and is not intended to limit the scope, applicability, or configuration of the invention. Rather, the ensuing description of the preferred exemplary embodiment(s) and exemplary embodiments will provide those skilled in the art with an enabling description for implementing a (preferred) exemplary embodiment of the invention. It should be understood that various changes may be made in the function and arrangement of elements without departing from the intent and scope of the invention as set forth.

The terminology used herein is for the purpose of describing particular embodiments only and is not intended to be limited to example embodiments of the invention. As used herein, the singular forms “a”, “an”, and “the” are intended to include the plural forms as well, unless the context clearly indicates otherwise. As used herein, the terms “and/or” and “at least one of” include any and all combinations of one or more of the associated listed items. Expressions such as “at least one of,” when preceding a list of elements, modify the entire list of elements and do not modify the individual elements of the list. The terms “comprises”, “comprising”, “includes” and “including”, when used herein, specify the presence of stated features, integers, steps, operations, elements, and/or components, but do not preclude the presence or addition of one or more other features, integers, steps, operations, elements, components, and/or groups thereof. Also, the term “exemplary” is intended to refer to an example or illustration.

While processes, steps, methods, algorithms, or the like described herein may be described in sequential order, such processes, steps, methods, and algorithms may be configured to work in alternate orders. In other words, any sequence or order of steps that may be described herein does not, in and of itself, indicate a requirement that the steps be performed in that order. The steps of the described processes may be performed in any order practical.

When an element is referred to as being “on”, “connected to”, “coupled to”, or “adjacent to” another element, the element may be directly connected or linked to another element. However, it should be understood that still another element may be present in the middle. On the other hand, when an element is referred to as being “directly connected” or “directly linked” to other elements, it should be understood that there is no other component in the middle.

As used herein, the terms “computer-readable storage medium”, “computer-readable medium”, “main memory”, “secondary storage”, “machine-readable medium” or “other storage medium” refers to any medium that participates in providing instructions to a processing unit for execution, including but not limited to read-only memory (ROM), programmable read-only memory (PROM), erasable programmable read-only memory (EPROM), random access memory (RAM), magnetic RAM, core memory, floppy disk, flexible disk, hard disk, solid-state drive, magnetic tape, CD-ROM, flash memory devices, a memory card and/or other machine-readable mediums for storing information. The aforementioned storage mediums may be realized by virtualization, and may be a virtual storage medium including a virtual storage medium in a cloud-based instance. The processing unit reads the data written in the primary storage medium and writes the data in the secondary storage medium. Therefore, even if the data written in the primary storage medium is lost due to a momentary power failure and the like, the data can be restored by transferring the data held in the secondary storage medium to the primary storage medium. The computer-readable medium is just one example of a machine-readable medium, which may carry instructions for implementing any of the methods and/or techniques described herein. Various forms of computer-readable media may be involved in carrying one or more sequences of one or more instructions to the processor for execution, including but not limited to, non-volatile media, volatile media, and transmission media. For example, the instructions may initially be carried on a magnetic disk from a remote computer. Alternatively, the remote computer can load the instructions into its dynamic memory and send the instructions to the system that runs one or more sequences of one or more instructions. Transmission media includes coaxial cables, copper wire, and fiber optics. Transmission media can also take the form of acoustic or light waves, such as those generated during radio-wave and infrared data communications.

A volatile storage may be used for storing temporary variables or other intermediate information during the execution of instructions by a processing unit. A non-volatile storage or static storage may be used for storing static information and instructions for the processor, as well as various system configuration parameters.

The storage medium may include a number of software modules that may be implemented as software codes to be executed by the processing unit using any suitable computer instruction type. The software code may be stored as a series of instructions or commands, or as a program in the storage medium.

A processing unit may be a microprocessor, a microcontroller, a digital signal processor (DSP), any combination of those devices, or any other circuitry configured to process information. A processing unit executes program instructions or code segments for implementing embodiments of the present invention. Furthermore, embodiments may be implemented by hardware, software, firmware, middleware, microcode, hardware description languages, or any combination thereof. When the embodiments are to be implemented by software, firmware, middleware, or microcode, the program instructions to perform the necessary tasks may be stored in a computer-readable storage medium. A processing unit(s) can be realized by virtualization and can be a virtual processing unit(s) including a virtual processing unit in a cloud-based instance.

An end device in the present invention may be a computing device, mobile phone, smartphone, personal digital assistants (PDAs), desktop computer, server computers, laptop, tablet, or other fixed and mobile electronic device that is capable of transmitting and receiving data packets.

The techniques described herein may be used for various wireless communication networks such as Code Division Multiple Access (CDMA), Time Division Multiple Access (TDMA), Frequency Division Multiple Access (FDMA), Orthogonal Frequency Division Multiple Access (OFDMA), Single Carrier Frequency Division Multiple Access (SC-FDMA) and other networks. The terms “network” and “system” are often used interchangeably. A CDMA network may implement radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement radio technology such as Global System for Mobile Communications (GSM). An OFDMA network may implement radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of the Universal Mobile Telecommunication System (UMTS). 3GPP Long Term Evolution (LTE) is a UMTS that uses E-UTRA, which employs OFDMA on the downlink and SC-FDMA on the uplink. UTRA, E-UTRA, UMTS, LTE, 5G, Satellite and GSM are described in documents from an organization named “3rd Generation Partnership Project” (3GPP). CDMA 2000 and UMB are described in documents from an organization named “3rd Generation Partnership Project 2” (3GPP2).

As used herein, an “aggregated connection” or a “tunnel” is a communication channel between two network devices that transmits data by encapsulating the data's Internet Protocol (IP) packets according to any suitable cryptographic tunneling protocol. A network device can be any electronic device, client, server, peer, service, application, or other object capable of sending, receiving, or forwarding information over communication channels in a network. Cryptographic tunneling protocols may include without limitation, Internet Protocol security (IPsec), Secure Socket Layer/Transport Layer Security (SSL/TLS), Datagram Transport Layer Security (DTLS), Microsoft Point-to-Point Encryption (MPPE), and Secure Shell (SSH).

An end-to-end connection referred to herein may be a connection-oriented protocol, such as Transmission Control Protocol (TCP), or a connectionless protocol, such as User Datagram Protocol (UDP), to transmit packets. Well-known protocols for deploying end-to-end connections include Layer 2 Tunnelling Protocol (L2TP), SSH protocol, Multi-protocol Label Switching (MPLS), and Microsoft's Point-to-Point Tunnelling Protocol (PPTP).

A network interface may be any of several types of network interfaces including Local Area Network (LAN) interface, Wide Area Network (WAN) interface, Wi-Fi interface, fiber optic interface, VPN interface, USB interface, PoE interface, etc. The network interface may be a virtual network interface, including a virtual network interface in a cloud-based instance.

The inter-connected network disclosed herein may use any of the several types of interconnected networks such as LAN, Metropolitan Area Network (MAN), WAN, the public switched telephone network (PSTN), the Internet, an intranet, an extranet, access network, Virtual Private Network (VPN), Enterprise Private Network (EPN) or similar networks.

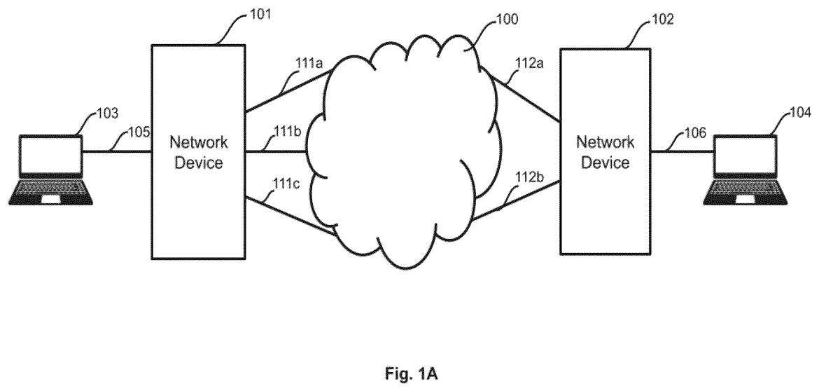

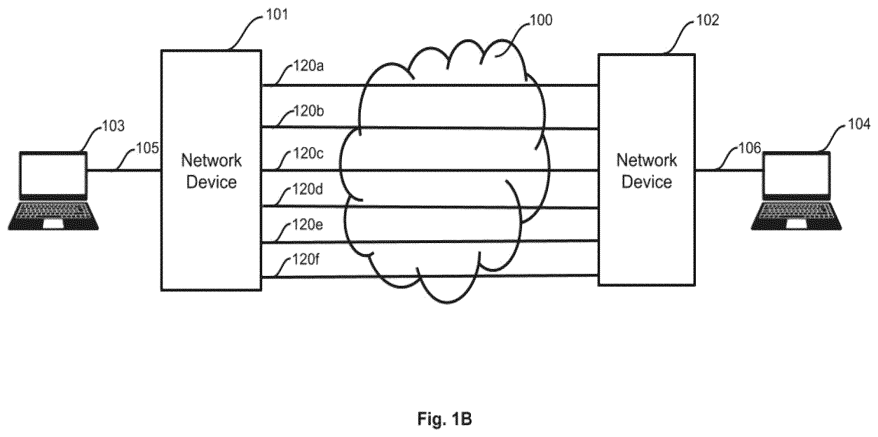

FIG. 1A illustrates a network environment according to the embodiments of the present invention. The network environment comprises at least first network device 101 and second network device 102, which are connected to each other via an interconnected network, such as interconnected network 100. For illustrative purposes, first network device 101 may comprise three network interfaces capable of connecting to three access networks 111a, 111b, and 111c (collectively, “access networks 111”) further accessing interconnected network 100; and second network device 102 may comprise two network interfaces capable of connecting to two access networks 112a and 112b (collectively, “access networks 112”) further accessing interconnected network 100. The network interfaces described herein may be any network interface, such as a LAN interface, that is capable of performing the functionality of a WAN interface.

Each of first network device 101 and second network device 102 may provide at least one network interface such that different end devices may be connected to the first network device 101 and the second network device 102. As illustrated in FIG. 1A, laptop 103 is connected to first network device 101 locally through connection 105, while laptop 104 is connected to second network device 102 locally through connection 106. Each of connection 105 and connection 106 may be wired or wireless.

The network environment may vary according to the desired network device and configuration. There is no limitation on the number of network interfaces in first network device 101 and second network device 102. There is also no limitation on the number of end devices connected to first network device 101 or second network device 102. The setting that only laptop 103 is connected to first network device 101 and only laptop 104 is connected to second network device 102 is solely for illustrative purposes. Access networks 111 and 112 may comprise the same or different types of connections and have similar or different latency and bandwidth capacities.

FIG. 1B illustrates a plurality of connections established between two network devices according to the embodiments of the present invention. Each of the plurality of connections may be an end-to-end connection established between a network interface of the first network device 101 and a network interface of the second network device 102. For illustrative purposes, three network interfaces of first network device 101 are capable of connecting to three access networks 111, while two network interfaces of second network device 102 are capable of connecting to two access networks 112. Accordingly, six end-to-end connections 120a-120f may be established through any of the access networks 111 and 112. For illustrative purposes, end-to-end connections 120a-120f are established through the access networks 111a and 112a, 111a and 112b, 111b and 112a, 111b and 112b, 111c and 112a, as well as 111c and 112b.

According to the embodiments of the present invention, first network device 101 may transmit data packets received from laptop 103 to second network device 102 through end-to-end connections 120a-120f, and further to laptop 104. First network device 101 may receive at least one acknowledgement for the data packets successfully transmitted.

For example, the data packets within a session may be distributed across and transmitted from first network device 101 to second network device 102 through end-to-end connections 120a, 120d, and 120f in any sequential order.

In one variant, at least one connection of end-to-end connections 120a-120f may be aggregated as one or more aggregated connections for transmitting data packets.

In one example, end-to-end connections 120a-120f are aggregated as one aggregated connection for transmitting data packets.

In another example, each of end-to-end connections 120a-120f is aggregated as an aggregated connection such that six aggregated connections are established for transmitting data packets.

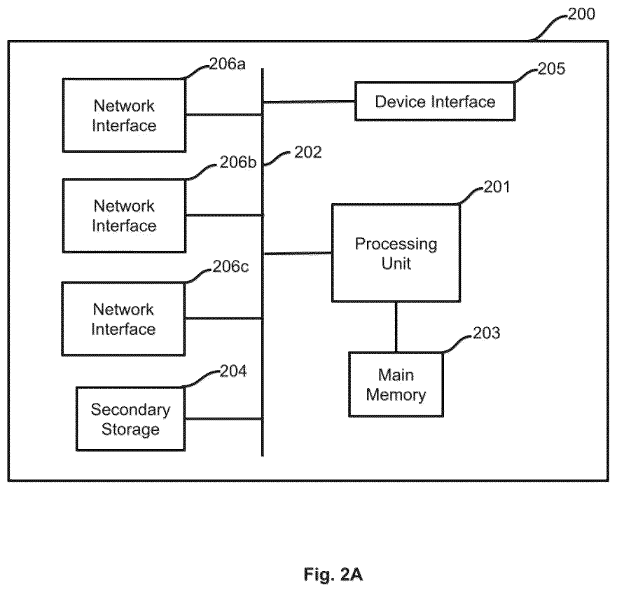

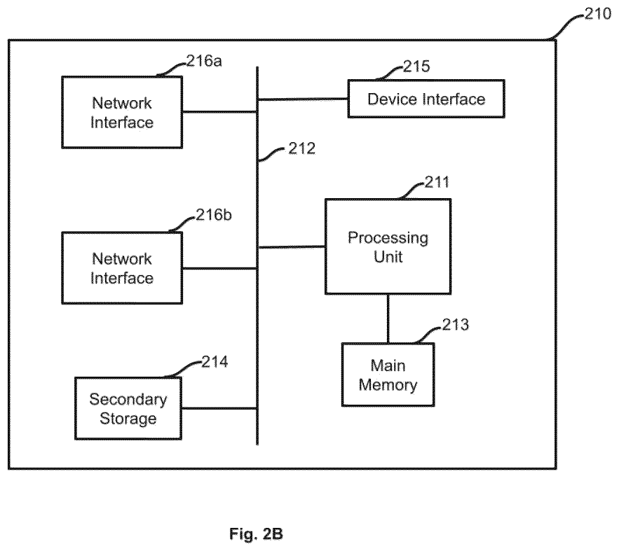

FIG. 2A is an illustrative block diagram of a first network device according to the embodiments of the present invention, which is similar to first network device 101 illustrated in FIGS. 1A and 1B. The first network device, such as first network device 200, comprises at least one processing unit, such as processing unit 201, system bus 202, main memory 203, secondary storage 204, device interface 205, and at least one network interface, such as network interfaces 206a-206c. Network interfaces 206a-206c may each be a LAN interface or a WAN interface. Processing unit 201 is connected to secondary storage 204, device interface 205, and network interfaces 206a-206c via system bus 202, which may be any of several bus structures including a memory bus, a peripheral bus, and a local bus using any variety of bus architectures. Main memory 203 is directly connected to processing unit 201 and may store program instructions for processing unit 201 to execute.

The device interface described herein may be any of the interfaces that may provide a connection with other external components, such as power interface, usb interface, reset button, antenna connectors, SIM card slot etc.

The first network device 200 is not limited to having three network interfaces and a device interface. For example, first network device 200 may comprise no device interface and may have more or less than three network interfaces.

FIG. 2B is an illustrative block diagram of a second network device according to the embodiments of the present invention, which is similar to second network device 102 illustrated in FIGS. 1A and 1B. The second network device, such as second network device 210 includes at least one processing unit, such as processing unit 211, system bus 212, main memory 213, secondary storage 214, device interface 215, and network interfaces 216a and 216b. Network interfaces 216a and 216b may each be a LAN interface or a WAN interface. Processing unit 211 is connected to secondary storage 214, device interface 215, and network interfaces 216a and 216b via system bus 212, which may be any of several bus structures including a memory bus, a peripheral bus, and a local bus using any variety of bus architectures. Main memory 213 is directly connected to processing unit 201 and may store program instructions for processing unit 211 to execute.

The device interface described herein may be any of the interfaces that may provide a connection with other external components, such as a power interface, USB interface, reset button, antenna connectors, SIM card slot, etc.

The second network device 210 is not limited to having two network interfaces and a device interface. For example, network device 210 may comprise no device interface and may have more or less than two network interfaces.

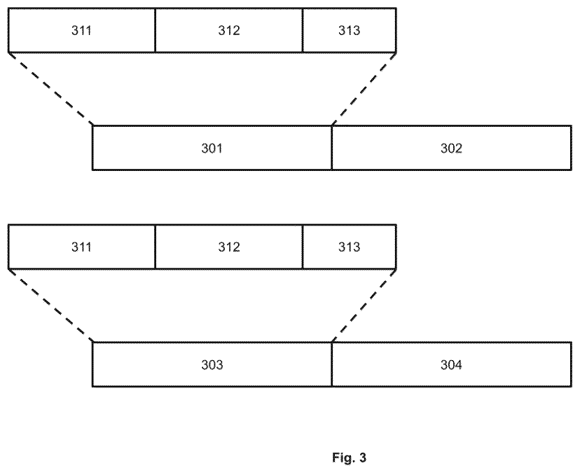

FIG. 3 is a diagram illustrating the difference between the packet structure of the original data packet and that of the error correction packet according to the embodiments of the present invention.

As illustrated in FIG. 3, the original data packet comprises header 301 and payload 302, which corresponds to the error correction packet comprising header 303 and payload 304.

In one embodiment, both header 301 of the original data packet and header 303 of the error correction packet are the same, both comprise source address 311, designated address 312, and tunnel information 313. However, payload 302 of the original data packet is different from payload 304 of the error correction packet. Instead of the payload of the original data packet, payload 304 comprises error correction feedback information for compensating the lost packet.

More specifically, the error correction feedback information described herein may be data or information including but not limited to one or more of the following: current network packet loss rate, current network packet drop rate, latency, RTT, feedback information sequence number, forward error correction control flag, and any network performance parameters related to the end-to-end connections used for transmitting the data packet. The current network packet loss rate is the current packet loss rate of the network or a connection.

The feedback information sequence number marks the error correction feedback information according to the packet loss rate. Different sets of error correction feedback information with the same packet loss rate share the same feedback information sequence number. The forward error correction control flag guides the peer to perform forward error correction coding, for example, for the peer to enable or disable forward error correction coding. If the second network device detects that the packet loss rate of the media data packets received from the first network device is very low or basically non-existent, it may include the forward error correction control flag in the error correction feedback information sent to the first network device, for enabling or disabling error correction.

In one variant, the error correction feedback information may be included in the header instead of the payload. Therefore, the original data packet and the error correction packet may have the same payload but a different header. Thus, tunnel information in header 301 may differ from that in header 303.

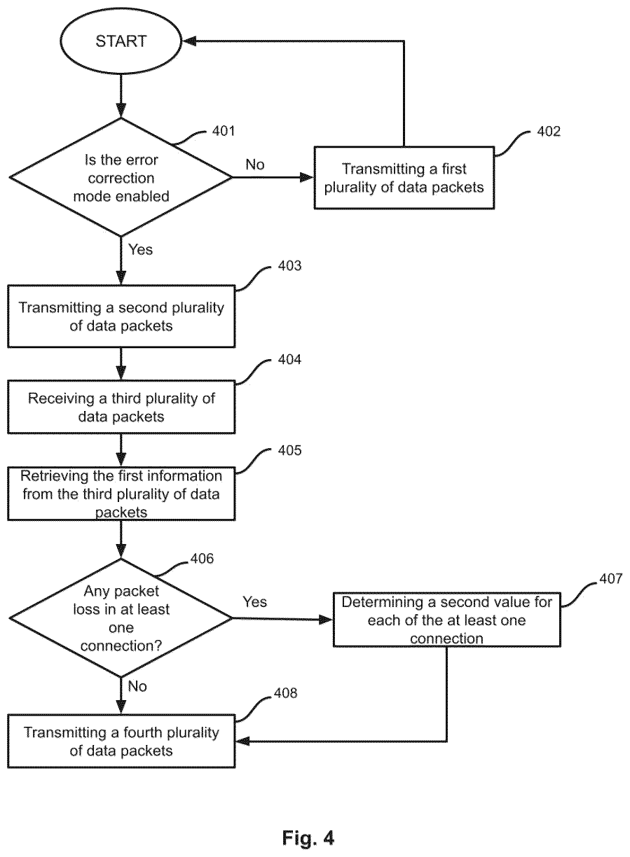

When transmitting the data packets from the first network device to the second network device through end-to-end connections 120a-120f, packet loss may occur in each of end-to-end connections 120a-120f. FIG. 4 is a diagram illustrating a method for handling packet loss at the first network device according to the embodiments of the present invention and should be viewed in conjunction with FIG. 1A.

In process 401, first network device 101 may determine whether an error correction mode is enabled or not. When the error correction mode is disabled, first network device 101 may perform process 402 for each of end-to-end connections 120a-120f. Otherwise, process 403 is performed.

There is no limitation on how the error correction mode is enabled, the error correction mode may be enabled by default, by the user or the administrator of first network device 101, or by first network device 101 when a packet loss threshold is exceeded.

In one example, if the error correction mode is enabled by default, process 403 may be performed once first network device 101 is powered on or end-to-end connections 120a-120f are established.

In another example, if the error correction mode is enabled by the user or the administrator of first network device 101, they may enable the error correction mode according to the network conditions.

In another example, the error correction mode is enabled by first network device 101 dynamically when the packet loss threshold is exceeded. The packet loss threshold may relate to any parameters associated with packet loss and/or delay in the at least one connection of end-to-end connections 120a-120f.

In process 402, when the error correction mode is not enabled, first network device 101 may transmit a first plurality of data packets to second network device 102 through end-to-end connections 120a-120f. The first plurality of data packets may be received from at least one of the local devices, such as laptop 103.

In process 403, when the error correction mode is enabled, first network device 101 may transmit a second plurality of data packets to second network device 102 through end-to-end connections 120a-120f.

In one embodiment, the payload of the first plurality of data packets and the payload of the second plurality of data packets are the same, but the second plurality of data packets further comprises a first request requesting first information from second network device 102.

In another embodiment, the first request is in the payload instead of the header, and therefore the header of the first plurality of data packets and the header of the second plurality of data packets are the same.

The first information described herein may be data or information including but not limited to one or more of the following: packet loss, packet drop rate, latency, RTT, checksums, logs, and any network performance parameters related to a particular connection of end-to-end connections 120a-120f.

In one embodiment, the first request is stored in the header of the at least one of the second plurality of data packets.

In another embodiment, the first request is stored in the payload of the at least one of the second plurality of data packets.

In one variant, instead of the data or information related to the particular connection of end-to-end connections 120a-120f, the first information may be the data or information related to end-to-end connections 120a-120f. First network device 101 may determine the data or information corresponding to the particular connection after receiving it.

In process 404, first network device 101 may receive a third plurality of data packets from second network device 102 through end-to-end connections 120a-120f. At least one of the third plurality of data packets may comprise the first information requested by first network device 101.

In one variant, an acknowledgment is received in process 404 instead of the third plurality of data packets. The acknowledgment may comprise the first information requested by first network device 101.

In process 405, first network device 101 may retrieve the first information from the third plurality of data packets.

In one embodiment, the first information may be stored in each of the third plurality of data packets being transmitted through end-to-end connections 120a-120f. For example, each of the third plurality of data packets comprises the same first information in their header.

In another embodiment, the first information may be stored only in the first data packet being transmitted through each of end-to-end connections 120a-120f.

There is no limitation on how the first information is stored in the third plurality of data packets. The embodiments described above are for illustrative purposes only.

In process 406, first network device 101 may determine, based on the first information, whether there is packet loss in the at least one connection of end-to-end connections 120a-120f. If there is packet loss in at least one connection of end-to-end connections 120a-120f, process 407 may be further performed. Otherwise, process 407 will be skipped.

For example, if, according to the first information, there is packet loss in only end-to-end connection 120a, process 407 will be further performed on end-to-end connection 120a only.

In process 407, first network device 101 may, according to the first information, determine a second value for each of the at least one connection of end-to-end connections 120a-120f.

The second value reflects the seriousness of packet loss in each of at least one connection of end-to-end connections 120a-120f under the error correction mode and is determined with reference to the number of packets lost in each of at least one connection of end-to-end connections 120a-120f.

In one embodiment, the second value is the number of packets lost in each of at least one connection of end-to-end connections 120a-120f.

In another embodiment, the second value is the number of packets lost in each of at least one connection of end-to-end connections 120a-120f, plus a reserved number. The reserved number represents a reserved slot made redundant in a block of data packets during data transmission. Accordingly, the reserved number may be any positive integer that is small enough to maintain a smooth data packet transmission in different scenarios. When there is a failure to transmit any error correction packets, first network device 101 may make use of the reserved slot for recovery of the lost data, so as to avoid the accumulation of the error correction packets pending to be transmitted and thereby preventing the ping-pong effect that brings delays and reduced network performance.

In one example, if the reserved number is 1, the second value is the number of packets lost in each of at least one connection of end-to-end connections 120a-120f, plus one. When the number of packets lost in end-to-end connections 120a, 120b, and 120c are 3, 0, and 0, the first network device may determine the second value for end-to-end connection 120a only, and the second value for end-to-end connection 120a is 4. In another example, if the reserved number is 2 and the number of packets lost in end-to-end connections 120 a, 120 b, and 120 c are 5, 2, and 1, the second value for end-to-end connections 120a, 120b, and 120c shall be 7, 4 and 3 respectively.

In another embodiment, the first network device may determine the second value for all of end-to-end connections 120a, 120b, and 120c, even if there is no packet loss for some of them. For example, when the number of packets lost in end-to-end connections 120a, 120b, and 120c are 3, 0, and 0, the first network device may determine the second value for end-to-end connections 120 a, 120 b, and 120 c to be 4, 1, 1 respectively, with the value “1” indicating that there is no packet loss.

One skilled in the art may know that error correction packets are normally transmitted to second network device 102, accompanied by the original data packets. Therefore, no matter whether the number of data packets being transmitted is unchanged or not, first network device 101 may dynamically change the ratio between the number of error correction packets and the number of original data packets being transmitted among each of end-to-end connections 120a-120f.

In process 408, first network device 101 may transmit a fourth plurality of data packets to second network device 102 through end-to-end connections 120a-120f. The fourth plurality of data packets may be a combination of the original data packets and the error correction packets.

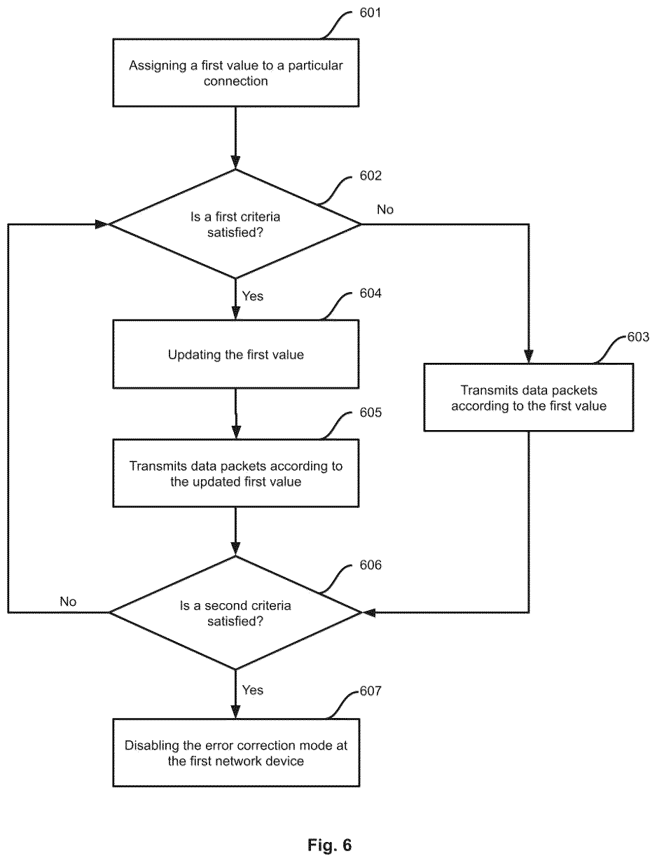

The ratio between the number of error correction packets and the number of original data packets being transmitted is based on a first value, which is the value related to the number of packets lost in the particular connection. The assignment of the first value will be discussed below in FIG. 6. It will also be explained below in FIG. 6 as to how the ratio may be determined by updating the first value with reference to the second value.

Each of the error correction packets may also be a forward error correction packet, an ARQ packet, or a parity packet. The error correction packets may comprise at least one second information selected from one or more of the following: codewords, sequence number, checksum, metadata, and parity bits.

In one embodiment, the second value is the ratio between the number of the original data packets and the number of error correction packets that are going to be transmitted. For example, if the second value is 0.25, then the ratio between the number of error correction packets and the number of the original data packets is 2:8.

In another embodiment, the second value is the number of error correction packets of the fourth plurality of data packets. For example, if the second value is 2, then the number of error correction packets is 2.

In another embodiment, the second value plus the reserved number determines the number of error correction packets of the fourth plurality of data packets. In one example, if the second value is 5 and the reserved number is 0, the number of error correction packets of the fourth plurality of data packets is 5.

In one variant, after performing process 405, first network device 101 may perform process 408 directly without performing processes 406 and 407 if first network device 101 is capable of adjusting the first value of end-to-end connections 120a-120f accordingly without the existence of the second value for each of end-to-end connections 120a-120f.

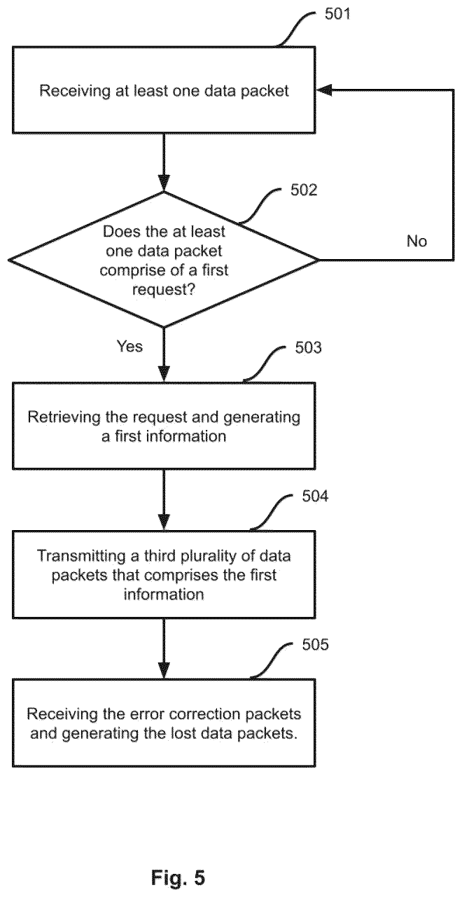

FIG. 5 is a diagram illustrating a method for handling packet loss at the second network device according to the embodiments of the present invention.

In process 501, second network device 102 may receive at least one data packet from first network device 101. The at least one data packet may be data packet(s) of the first plurality of data packets or the second plurality of data packets discussed in processes 402 or 403.

In process 502, second network device 102 may determine if the at least one data packet comprises a first request. If the at least one data packet received is the at least one of the second plurality of data packets, the first request is received, and process 503 may be further performed.

In process 503, second network device 102 may retrieve the first request from the at least one data packet, and generate the first information according to the first request. The first information may be the data or the information comprising at least the packet loss information.

There is no limitation on how second network device 102 determines the number of packets lost of each of end-to-end connections 120a-120f, any means that is capable of recognizing the packet loss may be applied at second network device 102, such as recognizing the local sequence number, and/or the detection of the anticipated heartbeat messages received. The heartbeat messages are small enough such that the overall throughput is not affected.

In process 504, second network device 102 may transmit the third plurality of data packets to first network device 101 through end-to-end connections 120a-120f, and the third plurality of data packets at least comprises the first information.

In one variant, instead of the third plurality of data packets, second network device 102 may transmit an acknowledgment to first network device 101 in process 504. The acknowledgment may comprise the first information requested by first network device 101.

In process 505, second network device 102 may receive the error correction packets. Based on the error correction packets received, second network device 102 may compensate for the lost data packet, or generate new packet(s) equivalent or similar to the lost data packet.

FIG. 6 is a diagram illustrating how the first network device may assign or update the first value for the particular connection, which should be viewed in conjunction with FIG. 4. The particular connection is a connection of end-to-end connections 120a-120f.

In process 601, once the error correction mode is enabled, the first network device 101 may assign the first value to the particular connection, which is a value reflecting the number of packets lost in the particular connection in the same way adopted for the second value.

In one preferred embodiment, the first value is the number of packets lost in the particular connection plus the reserved number.

In another embodiment, the first value is the number of packets lost in the particular connection.

In one variant, instead of the number of packets lost in the particular connection, the first value may be a value proportional to the number of packets lost in the particular connection.

In one embodiment, if there is no packet loss for the particular connection, first network device 101 may assign 0 as the first value of the particular connection. In another embodiment, if there is no packet loss for the particular connection, first network device 101 may assign any number indicating that no error correction packet will be transmitted as the first value of the particular connection.

In one variant, process 601 may be performed anytime before receiving the first information from second network device 102, such as before performing process 407 as illustrated in FIG. 4.

The first value may subsequently be updated, depending on and with reference to the second values. After initialization, first network device 101 may determine whether there is packet loss in the particular connection, and further, the second values, according to the first information received from second network device 102.

In process 602, first network device 101 may determine if a first criteria is satisfied in respect of the particular connection. If the first criteria is satisfied, first network device 101 may further perform process 604. The first criteria is a condition related to the second value(s).

In one variant, first network device 101 may perform process 602 directly without performing process 601.

In one embodiment, the first criteria is satisfied when the next N second values are the same, but different from the first value, where N is a positive integer. For example, when N is 4 and the first value is 2, the first criteria is satisfied when the next four second values are all 6.

In another embodiment, the first criteria is satisfied when there are N consecutive changes in the second value. For example, if N is 3 and the first value is 2, the first criteria is satisfied when the next three second values are 4, 6, and 5, since two consecutive changes are detected (from 2 to 4, from 4 to 6, and from 6 to 5).

In another embodiment, the first criteria is satisfied when the average of the next N second values determined is different from the first value. For example, if N is 2 and the first value is 3, when the next two second values are 3 and 5, the first criteria is satisfied since the average of the next two second values equals to 4, i.e. different from the first value. The statistical measure described herein is for illustrative purposes only. Other statistical measures, such as mode, median, maximum, and minimum, may also be applied.

In other variants, first network device 101 may also set the first criteria by any means such that the first value may be updated to fulfill the needs of the networking requirement, the two embodiments listed above are for illustrative purposes only.

If the first criteria is not satisfied, in process 603, first network device 101 may transmit the fourth plurality of data packets according to the first value. After that, process 606 may further be performed to determine whether a second criteria is satisfied.

If the first criteria is satisfied, in process 604, first network device 101 may update the first value to the particular connection. There is no limitation on how the first value is to be updated. The first value may be updated by any means such that the change in the number of packets lost within a period of time is reflected.

In one embodiment, the updated first value is equivalent to the average of the next N second values used in process 602 for determining the first criteria. For example, if N is 3, when the next three second values are 5, 3, and 4, the updated first value will be 4. Again, the statistical measure described herein is for illustrative purposes only. Other statistical measures, such as mode, median, maximum, and minimum, may also be applied.

In another embodiment, the updated first value is proportional to the average of the next N second values used in process 602 for determining the first criteria. For example, if N is 3, when the next 3 second values are 2, 3, and 4, the updated first values shall be the average of the next N second values times k (i.e. 3*k), with k being a constant value fixed for the particular connection when the error correction mode is enabled.

The value of N may be configured by the manufacturer of first network device 101, but adjustable by the user or the administrator of first network device 101 to adapt to the varying network environment.

In process 605, first network device 101 may transmit the fourth plurality of data packets according to the updated first value.

In one variant, first network device 101 may perform process 605 followed by process 604.

In process 606, first network device 101 may determine if the second criteria is satisfied in respect of the particular connection. If the second criteria is satisfied, first network device 101 may further perform process 607. Otherwise, first network device 101 may perform process 602 again to determine if the first criteria is satisfied for the particular connection.

In one embodiment, the second criteria is satisfied when the next M second values indicate that there is no packet loss or nearly no packet loss for the particular connection, with M being a positive integer. For example, if M is 10 and the first value is 2, the second criteria is satisfied when the next 10 second values are 1, this indicates that there is no packet loss for the particular connection, and process 607 may be further performed to disable the error correction mode at the first network device.

In another embodiment, the second criteria is satisfied when the next M second values indicate that the network environment becomes worse when the error correction mode is applied.

There is no limitation on how M is determined. For example, a counter may be applied for first network device 101 to determine the M.

If the second criteria is satisfied, in process 607, first network device 101 may disable the error correction mode and transmit the data packets without the error correction packet after a time threshold.

In one embodiment, the time threshold is 0 ms such that first network device 101 may disable the error correction mode once the second criteria is satisfied.

In another embodiment, the time threshold is any positive value, for example, 10 ms, such that possible conflict with other system processes may be avoided.

In one variant, processes 606 and 607 are optional such that the error correction mode stays on for first network device 101.

In another variant, first network device 101 may determine on the second criteria before the first criteria. Therefore, first network device 101 may perform process 606, followed by process 602.

In another variant, first network device 101 may determine on the second criteria and the first criteria concurrently. If the second criteria is satisfied, first network device 101 may disable the error correction mode and transmit the data packets without error correction packet, and may not perform process 607 even if the first criteria is satisfied.

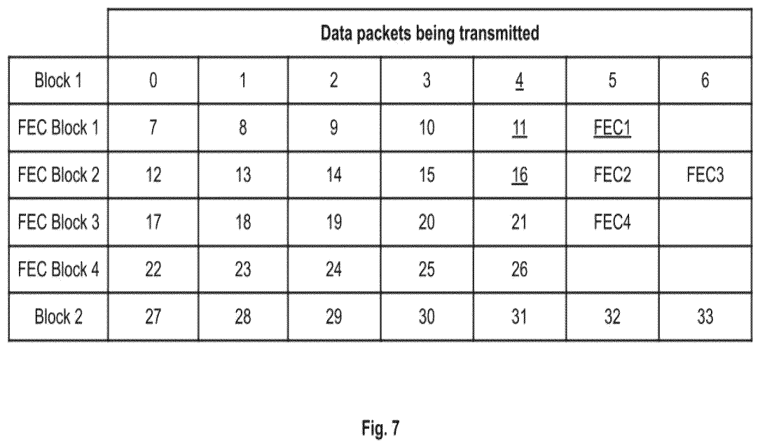

FIG. 7 is a table showing an example of the data packets being transmitted from first network device 101 to second network device 102 through the particular connection according to the embodiments of the present invention. Each row of the table represents a block of data packets being transmitted from first network device 101 to second network device 102 through end-to-end connection 120a, and the maximum number of data packets that may be transmitted in each block of data packets through end-to-end connection 120a is 7. For illustrative purposes, six blocks of data packets are transmitted, named “Block 1”, “FEC Block 1”, “FEC Block 2”, “FEC Block 3”, “FEC Block 4”, and “Block 2”.

As illustrated in the first row “Block 1”, without enabling the error correction mode, seven original data packets (data packets with sequence numbers 0-6) are transmitted from first network device 101 to second network device 102 through end-to-end connection 120a. However, the original data packet with sequence number 4, which is underlined, is lost during the transmission. Therefore, the error correction mode may be enabled and the method disclosed in the present invention may be applied when the next block is being transmitted.

Assume the first value is the number of packets lost in the end-to-end connection 120a plus the reserved number. If the reserved number is assumed to be 1, since the number of packets lost in Block 1 is 1, the first value becomes 2 for transmitting the “FEC Block 1”. Accordingly, when transmitting “FEC Block 1”, only the original data packets with sequence numbers 7-11 and error correction packet “FEC1” are transmitted, as illustrated in the second row, with the last slot being reserved because of the reserved number. Error correction packet “FEC1” may comprise the at least one second information related to the original data packet with sequence number 4.

During the transmission of “FEC Block 1”, the original data packet with sequence number 11 and error correction packet “FEC1”, which are underlined, are lost. Therefore, the error correction packet corresponding to the original data packets with sequence numbers 4 and 11 may be scheduled to be transmitted in the future blocks. For illustrative purposes, both error correction packets corresponding to the original data packets with sequence numbers 4 and 11 are scheduled to be transmitted in the next block.

In the third row, during the transmission of “FEC Block 2”, other than transmitting the original data packets with sequence number 12-16, and one of the error correction packets, such as “FEC2”, first network device 101 may utilize the reserved slot to transmit another error correction packet “FEC3”. Error correction packets “FEC2” and “FEC3” may comprise at least one second information related to the original data packet with sequence numbers 4 and 11.

In one variant, if the reserved slot is occupied for other purposes, first network device 101 may transmit “FEC2” in the next block instead of “FEC Block 2”.

Again, during the transmission of block “FEC Block 2”, the original data packet with sequence number 16, which is underlined, is lost. Therefore, the error correction packet corresponding to the original data packet with sequence number 16 will be transmitted in the next block.

In the fourth row, first network device 101 may transmit the original data packets with sequence numbers 17-21, and error correction packets “FEC4” in “FEC Block 3”, and no packet loss during transmitting this block. When transmitting each block, the method disclosed in the present invention may be performed from time to time, therefore the first criteria and the second criteria may be determined from time to time. Assuming after the transmission of FEC Block 4, the second criteria are not satisfied here, the error correction mode stays on for transmitting the next block.

In the fifth row, “FEC Block 4” comprises the original data packets with sequence numbers 22-26 being transmitted without an error correction packet. Again, no packet loss during transmitting this block. Assuming the second criteria is satisfied here, the error correction mode may be disabled by performing process 607 at first network device 101.

In one variant, if the second value is the number of packets lost in each of at least one connection of end-to-end connections 120a-120f plus the reserved number, then the number of the original data packets being transmitted in each block should be adjusted by considering the reserved number.

Consequently, in the sixth row, only the original data packets are being transmitted until the error correction mode is enabled again. Therefore, only the original data packets with sequence numbers 27-33 are transmitted in “Block 2”.

There is no limitation on the maximum number of data packets that may be transmitted in each block of data packets for any of the end-to-end connections, 7 data packets are for illustrative purposes only.

As illustrated, by applying the adaptive error correction mode, the network device may improve the transmission of data packets by balancing between the network resources and compensating for packet loss. If the error correction mode is enabled without adaptively changing, part of the block may be occupied even if there is no need to compensate for any lost packets, and the network performance of a connection may be lower than expected. By applying the method disclosed in the present invention, each of end-to-end connections 120a-120f may transmit the data packet with the error correction mode adaptively, and the overall performance may be improved with the compensation of the lost packet.

1. A method for transmitting data packets from a first network device to a second network device, comprising:
when the error correction mode is enabled:
i. transmitting a first plurality of data packets to the second network device through end-to-end connections;
ii. receiving a second plurality of data packets from the second network device through the end-to-end connections;
iii. determining, based on first information, a first value for each of the at least one of the end-to-end connections; and
iv. transmit a third plurality of data packets to the second network device through the end-to-end connections;
wherein the third plurality of data packets comprises original data packets and error correction packets; and
wherein the first information is stored in at least one of the second plurality of data packets.

2. The method of claim 1, wherein the first value for each of the at least one of the end-to-end connections is the number of packets lost corresponding to a connection of the end-to-end connections.

3. The method of claim 1, further comprising:
determining a second value for each of the at least one connection of the end-to-end connections.

4. The method of claim 1, wherein the first value is updated if a first criteria is satisfied.

5. The method of claim 1, wherein the error correction mode is disabled if a second criteria is satisfied.

6. The method of claim 4, wherein the first criteria is satisfied when N consecutive change in second value is detected.

7. The method of claim 5, wherein the second criteria is satisfied when next M second values indicate that there is no packet loss.

8. The method of claim 1, wherein the first plurality of data packets comprises the first request for requesting the first information.

9. The method of claim 1, wherein the end-to-end connections are aggregated as an aggregated connection.

10. The method of claim 1, wherein the first value may further comprise a reserved number.

11. A first network device, comprising:
a plurality of network interfaces;
at least one processing unit;
at least one non-transitory local storage medium storing program instructions executable by the at least one processing unit for recreating missing data packets of a data session established between the first communications router and the second communications router through an aggregated connection, comprising:
when there is packet loss for at least one of the end-to-end connections:
i. transmitting a first plurality of data packets to the second network device through the end-to-end connections;
ii. receiving a second plurality of data packets from the second network device through the end-to-end connections;
iii. determining a first value for each of the at least one of the end-to-end connections according to first information; and
iv. transmit a third plurality of data packets to the second network device through the end-to-end connections;
wherein the first information are stored in at least one of the second plurality of data packets.

12. The first network device of claim 11, wherein the first value for each of the at least one of the end-to-end connections is the number of packets lost corresponding to a connection of the end-to-end connections plus one.

13. The first network device of claim 11, further comprising:
determining if the error correction mode is enabled.

14. The first network device of claim 11, wherein the first value is updated if a first criteria is satisfied.

15. The first network device of claim 13, wherein the error correction mode is disabled if a second criteria is satisfied.

16. The first network device of claim 14, wherein the first criteria is satisfied when N consecutive change for the second value is detected.

17. The first network device of claim 15, wherein the second criteria is satisfied when there are next M second values indicating that there is no packet loss.

18. The first network device of claim 11, wherein the first plurality of data packets comprises the first request for requesting the first information.

19. The first network device of claim 11, wherein the end-to-end connections are aggregated as an aggregated connection.

20. The first network device of claim 11, wherein the third plurality of data packets comprises the error correction packet(s).
